(19) United States
(12) Patent Application Publication
(10) Pub. No.: US 2021/0278059 A1
(43) Pub. Date: Sep. 9, 2021

(54) DIGITAL LAMPSHADE DISPLAY AND METHODS THEREOF

(71) Applicants: Peter Garrett, Santa Cruz, CA (US); Paul Regen, Felton, CA (US); Mark Boys, Aromas, CA (US); Ned Hoffman, Sebastopol, CA (US)

(72) Inventors: Peter Garrett, Santa Cruz, CA (US); Paul Regen, Felton, CA (US); Mark Boys, Aromas, CA (US); Ned Hoffman, Sebastopol, CA (US)

(21) Appl. No.: 16/005,603

(22) Filed: Jun. 11, 2018

Related U.S. Application Data
(60) Provisional application No. 62/519,081, filed on Jun. 13, 2017.

(51) Int. Cl. F21V 1/16; G06F 3/14; G09G 3/00; H04W 76/10; G08C 17/02; F21V 1/04; F21V 23/04

(52) U.S. Cl. CPC F21V 1/16; G06F 3/14; G09G 3/035; H04W 76/10; G08C 17/02; H04W 4/80; F21V 23/0435; F21V 23/0485; G09G 2370/06; G09G 2370/16; F21V 1/04

(57) ABSTRACT

The present invention creates the world's first Digital Lampshade Display utilizing new lighting and display technologies such as Organic Light Emitting Diodes (OLED), Active-Matrix Organic Light-Emitting Diodes (AMOLED), Organic Light Emitting

Transistors (OLET), and E-Ink, among others. The invention herein can emit light from both the exterior and interior surface(s) of its lampshade, and will provide the user with a display upon which digital images and non-static motion imagery may be viewed. The invention will further allow the user to download images and motion imagery onto its display lampshade, to change a room's decorative and aesthetic feel. The invention will further enable the user to use the Wireless Remote Control to control the lampshade's functions such as adjusting brightness and/or contrast, selecting images to display, etc. Thus the invention herein will give the user the ability to customize on-command the color, design, pattern, and illumination characteristics of their lampshade(s).

### CROSS-REFERENCE TO RELATED APPLICATION

The instant utility patent application claims the benefit of priority to provisional patent application Ser. No. 62/519,081, filed on Jun. 13, 2017, all of which is incorporated herein by reference.

### BACKGROUND OF THE INVENTION

### 1. Field of the Invention

The present invention is in the field of lighting and aesthetics; and pertains more particularly to a lampshade which also serves as an electronic display, upon which a user is able to display and view images and non-static motion imagery.

### 3. Discussion of the State of the Art

Typically a lampshade is a fixture that covers the light bulb on a lamp to diffuse the light it emits. Most lampshades are conical or cylindrical in form, and may be mounted onto floor, desk, wall or tabletop lamps, as well as suspended lamp models. Lampshades can be made from a wide range of materials, including glass. Beyond its practical purpose, significant emphasis is also usually given to the lampshade's decorative and aesthetic features.

Recent advancements in lighting technologies have made it possible to deliver energy efficient, colorful, thin, and light-weight digital displays. Organic Light Emitting Diodes (OLED), Active-Matrix Organic Light-Emitting Diodes (AMOLED), Organic Light Emitting Transistors (OLET), E-Ink and various other lighting and display technologies can now be used to create new lighting and display inventions that will revolutionize the lighting and display industries. What is clearly needed are new lighting and display technologies to create the world's first Digital Lampshade Display replacing the bland lamp shades of the past.

### SUMMARY OF THE INVENTION

It occurred to the inventors that a new invention was needed in this field. Such an invention may be used with any standard lamp. Such an invention may be operated with or without a light bulb in a standard lamp. Such an invention can emit light from both its exterior and interior surface(s). In one embodiment light can be directed in different directions such as up, down or sideways. Such an invention will provide the user with a display upon which static digital images and non-static digital motion imagery may be viewed. Such an invention will allow the user to download images and motion imagery to be utilized by the invention, to change a room's decorative and aesthetic feel. Such an invention will give the user the ability to change the color, design, pattern, and illumination characteristics of their lampshade(s) to suit their needs.

Such an invention may contain one or more USB connectors to connect to a companion lamp when not being used with a standard lamp. Such an invention may contain a Wireless communication facility which will pair with a companion wireless remote control. Such an invention will allow the user to use the wireless remote control to control the lampshade's functions such as: tuning the lampshade ON or OFF, adjusting brightness and/or contrast, selecting images to display, speeding up or slowing down dynamic imagery, etc.

Such an invention will allow the user to download a software application from the Internet in order to interact/interface with the lampshade. Such an invention will have a layer of fabric on its exterior surface; allowing the lampshade to appear as a regular lampshade when the power is turned off. Such an invention in, low power mode, may also display a faux fabric digitally so that one could not tell if the shade was cloth, glass or another material.

In one preferred embodiment of the invention, the digital lampshade display comprises a lampshade connected to a companion lamp, said lampshade being composed of a flexible material operable to be wrapped about the exterior of a formed shape and further operable to display digital images and non-static motion imagery for viewing by a user, wherein the flexible material comprises any of the following: Organic Light Emitting Diodes (OLED), Active-Matrix Organic Light-Emitting Diodes (AMOLED), Organic Light Emitting Transistors (OLET), and/or E-Ink.

In one preferred embodiment of the invention of the invention, the digital lampshade display further comprises a rigid frame composed of any of the following: metal, plastic, glass, and/or composite material. Any other material known may also be used.

In one preferred embodiment of the invention of the invention, the rigid frame further comprises a hollow core operable to store electrical and data wirings, wherein said wirings are operable to transmit electricity and electronic images to the digital lampshade display. This may also be accomplished wirelessly.

In one preferred embodiment of the invention of the invention, the digital lampshade display further comprises a semi-transparent layer of fabric operable to be wrapped over an exterior surface of the digital lampshade display. The display may also emulate this semi-transparent layer of fabric electronically or digitally.

In one preferred embodiment of the invention of the invention, the digital lampshade display further comprises a USB connection to the companion lamp.

In one preferred embodiment of the invention of the invention, the digital lampshade display further comprises a wireless communication facility, wherein a user may pair a digital appliance such as computer, smartphone, smart tablet, personal digital assistant, remote or light switch to the wireless communication facility via Bluetooth and/or Wi-Fi, and wherein the user may control the digital lampshade display and/or the companion lamp via the paired computer, smartphone or any digital appliance mentioned above, to perform any of the following: downloading and displaying pre-set image or video files from the Internet or from stored media on the computer or smartphone or any digital appliance mentioned above; turning the companion lamp or digital lampshade display on or off; turning audible sound levels up or down; and/or, selecting brightness of the companion lamp or digital lampshade display.

In one preferred embodiment of the invention, the companion lamp further comprises a data port such as a memory card reader operable to load images, patterns and/or video files to be displayed.

In one preferred embodiment of the invention, the companion lamp further comprises a touch sensitive illuminated control pad, wherein the user may touch the touch sensitive illuminated control pad with a finger to adjust the lighting level of the digital lampshade display and or a light bulb. The user may touch the touch sensitive illuminated control pad with a finger to adjust any of the parameters of the invention normally accomplished by buttons, knobs or other methods. Double taps or triple taps may switch the touch pad to other adjustments as such as audio, pattern changes or any of the other parameters mentioned in this specification

In one preferred embodiment of the invention, the companion lamp further comprises any of the following: a retractable power cord, an internal rechargeable battery, an alarm clock, audio speakers, a beverage cup warmer, and/or a docking cradle including wireless charging of the rechargeable battery via capture of wireless signals via an antenna. Put simply, the antenna receives the RF or other signal and feeds it to a rectifying circuit, which turns the signal into direct current (DC). This DC energy is then fed into a power management module that boosts the voltage. This voltage is used to charge the battery or other energy source, such as a super-capacitor for example.

In another exemplary embodiment of the invention, the docking cradle is further operable to recharge any of the following: a smartphone, cell phone, an MP3 player or any digital assistant or appliance mentioned above.

In another preferred embodiment of the invention, the digital lampshade display further comprises an orb shape, wherein three dimensional images or video files are operable to be displayed and or rotated, such as that of the Earth, the Moon, and or cloud formations. Replications of the universe and or constellations may also be replicated with this inventive device. In another preferred embodiment of the invention, the digital lampshade display further comprises touch control operable to provide the user with an interactive experience via touching the orb (the orb is made or coated with a touch sensitive material) itself to view additional data, magnification, and or related visual media.

In another preferred embodiment of the invention, the digital lampshade display is further operable to be disconnected from the companion lamp and applied to covering a round bauble such as a Christmas tree ornament.

In another exemplary embodiment of the invention, the digital lampshade display is further operable to be disconnected from the companion lamp and applied to covering a light sconce.

In another exemplary embodiment of the invention, the digital lampshade display is further operable to retrofit onto an existing companion lamp via a threaded male socket cap which can be inserted into a threaded light socket of the companion lamp, wherein the digital lampshade display further comprises a wireless communication facility such as Bluetooth or Wi-Fi.

### BRIEF DESCRIPTION OF THE DRAWING FIGURES

FIG. 1 is an illustration of a Digital Lampshade Display, according to the embodiment of the present invention.

FIG. 2 is an overhead illustration of a Digital Lampshade Display.

FIG. 3 is a cut-away illustration of a Digital Lampshade Display, detailing a connection to a companion lamp via USB.

FIG. 4 is an illustration of a Companion Lamp, for a Digital Lampshade Display.

FIG. 5 is a bottom illustration of a Companion Lamp, for a Digital Lampshade Display.

FIG. 6 is an illustration of a Smartphone being used as a remote control, to select a pattern to display on a Digital Lampshade Display.

FIG. 7 is an illustration of a Retro-fit Digital Lampshade Display for an existing lamp base.

FIG. 8 is an illustration of a Tabletop Lamp with a Digital Lampshade Display, and containing a Built-in Alarm Clock.

FIG. 9 is an illustration of a Tabletop Lamp with a Digital Lampshade Display, and containing a Built-in Alarm Clock; detailing the lamp's base.

FIG. 10 is an illustration of a Tabletop Lamp with a Digital Lampshade Display, and containing a Cup Warmer; detailing the lamp's base.

FIG. 11 is an illustration of an Orb-Shaped Digital Lampshade Display.

FIG. 12 is an illustration of a Porch Light Digital Display.

FIG. 13 is an illustration of a Light Sconce Digital Display.

### DESCRIPTION OF THE PREFERRED EMBODIMENTS

It should be appreciated that the particular implementations shown and described herein are illustrative of the invention and its many preferred embodiments and are not intended to otherwise limit the scope of the present invention in any way. Indeed, for the sake of brevity, conventional elements of lamps and lampshades may not be described in detail herein. Furthermore, the various figures contained herein are intended to represent illustrative functional embodiments of the invention and that many alternative or equivalent configurations, elements, and structures are intended to be within the scope of the present invention. It will further be appreciated that the invention illustratively disclosed herein suitably may be practiced in the absence of any element which is not explicitly required herein.

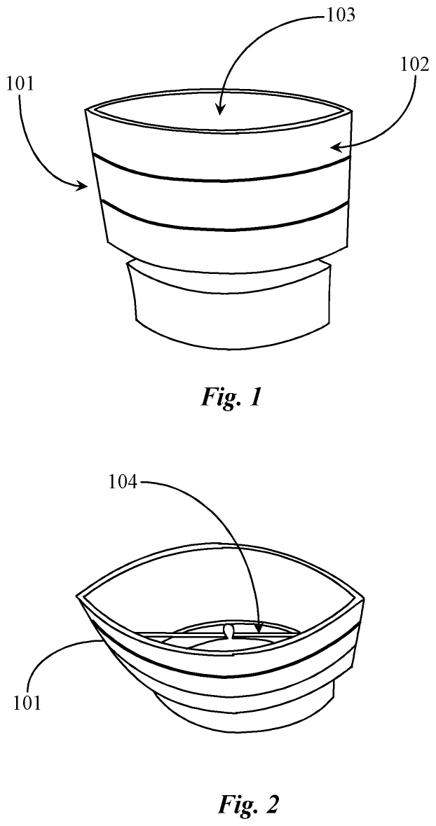

FIG. 1 is an illustration of a Digital Lampshade Display 101, according to the embodiment of the present invention. In one embodiment, the Digital Lampshade Display may be made from Organic Light Emitting Diodes (OLED), Active-Matrix Organic Light-Emitting Diodes (AMOLED), Organic Light Emitting Transistors (OLET), E-Ink or any other viable, flexible display technology which may be wrapped around the exterior of a formed shape. In this embodiment, the Digital Lampshade Display may contain at least one emissive layer on the Exterior Surface 102, of the Digital Lampshade Display; and at least one emissive layer on the Interior Surface 103, of the Digital Lampshade Display. In this embodiment, the Digital Lampshade Display may emit light from both its Exterior Surface and its Interior Surface. In this embodiment, the user may upload and view both static and/or full motion digital imagery on the Exterior Surface 102 of the Digital Lampshade Display. In this embodiment, the Digital Lampshade Display may be operated with or without the use of a light bulb.

FIG. 2 is an overhead illustration of a Digital Lampshade Display. In one embodiment, the internal structure of the Digital Lampshade Display 101 may contain a Rigid Frame 104. In one embodiment, the Rigid Frame 104 may be made from metal, plastic or any other viable, rigid composite material. In one embodiment, the Rigid Frame may be hollow to allow for the storing of electrical and data wiring to provide electricity to the Digital Lampshade Display; and for the transferring of electronic images to be displayed on the Exterior Surface of the Digital Lampshade Display.

In another embodiment, the Digital Lampshade Display 101 may contain a semi-transparent layer of fabric or any other viable type of decorative material, which may be wrapped over the Exterior Surface of the Digital Lampshade Display 101. In this embodiment, the semi-transparent layer of fabric (not shown) may give the Digital Lampshade Display the appearance of a normal lampshade when it is powered OFF. In another embodiment, the static and/or full motion digital imagery which is displayed on the Exterior Surface of the Digital Lampshade Display may be visible through the semi-transparent layer of fabric when the Digital Lampshade Display is powered ON.

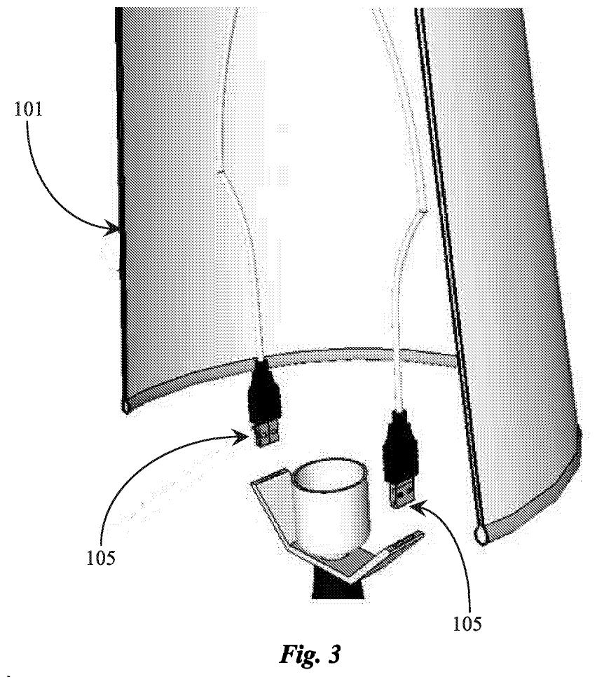

FIG. 3 is a cut-away illustration of a Digital Lampshade Display 101, detailing a connection to a companion lamp via USB connector(s) 105. In one embodiment, the Digital Lampshade Display may contain USB connector(s) 105, which may be connected to the Rigid Frame shown in FIG. 2. In this embodiment, power and static and/or full motion digital imagery may be supplied to the Digital Lampshade Display.

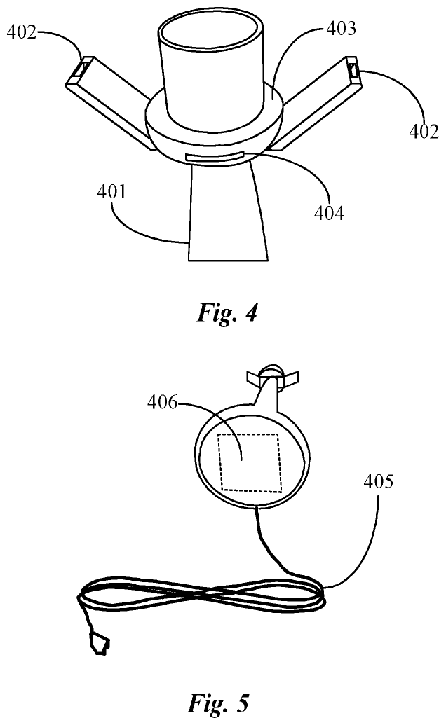

FIG. 4 contains elements 401, a companion lamp, element 402 are UBS ports. Element 403 is a wireless communication facility and element 404 is a touch sensitive illuminated control pad. FIG. 4 is an illustration of a Companion Lamp 401, for a Digital Lampshade Display, according to the embodiment of the present invention. In one embodiment, the Companion Lamp may contain USB Port(s) 402. In one embodiment, the USB Connectors, which are connected to the Rigid Frame on the Digital Lampshade Display, may be plugged into the USB Port(s). In this embodiment, power and static and/or full motion digital imagery may be supplied to the Digital Lampshade Display.

In another embodiment, the Companion Lamp may also contain a Wireless Communication Facility 403. In one embodiment, the user may pair their computer or Smartphone to the Wireless Communication Facility via Bluetooth, WI-Fi or any other viable wireless communications protocol or frequency. In this embodiment, the user may upload or remove static and/or full motion digital imagery to/from the Companion Lamp.

In another embodiment, the user may use their paired computer or Smartphone to access the internet, where pre-set images or animations may be downloaded from a specific website to be viewed on the Digital Lampshade Display as pictured in FIG. 101. In another embodiment, the user may download a specific theme (such as a movie theme) to be displayed on the Digital Lampshade Display. In another embodiment, the user may use their paired computer or Smartphone to control the Digital Lampshade Display's functions (such as turning ON/OFF, selecting brightness, selecting images to display, etc.).

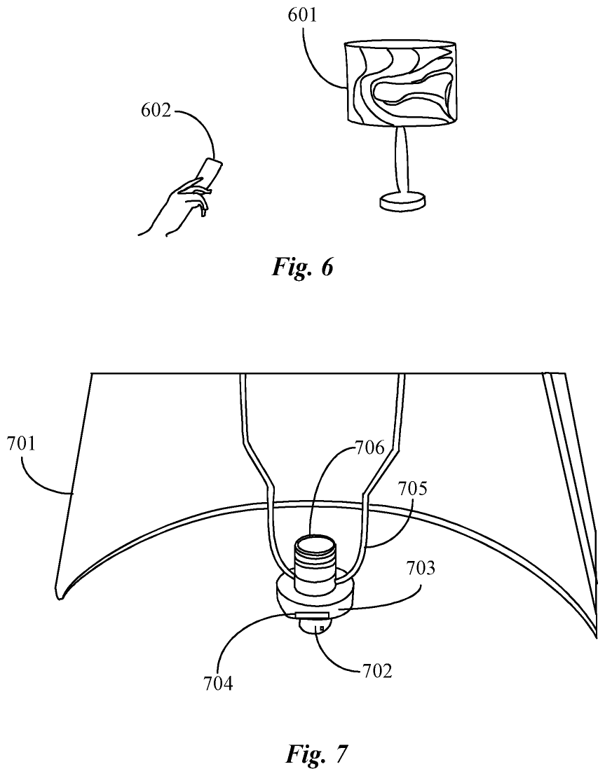

In another embodiment, the Companion Lamp's Wireless Communication Facility may also be paired to a Wireless Remote 602 as shown in FIG. 6. In this embodiment, the user may use the Wireless Remote to control element 601 the Digital Lampshade Display's functions or to turn the light bulb ON or OFF as shown in FIG. 6.

In another embodiment, the Companion Lamp may also contain a Data Port (such as a memory card reader or any other viable type of media reader). In this embodiment, the user may use the Data Port to load images, patterns, video files, etc. onto the Companion Lamp.

In another embodiment, the Companion Lamp may also contain a Touch Sensitive Illuminated Control Pad 404 in FIG. 4. In one embodiment, the user may touch the Touch Sensitive Illuminated Control Pad with a finger to adjust the lighting level of the Digital Lampshade Display and/or the light bulb.

FIG. 5 is a bottom illustration of a Companion Lamp 401, for a Digital Lampshade Display. In another embodiment, the Companion Lamp may contain a Retractable Power Cord 405. In one embodiment, the user may extend the Retractable Power Cord from the base of the Companion Lamp and plug it into an electrical outlet to supply power to the Companion Lamp and/or the Digital Lampshade Display. In another embodiment, the user may unplug the Retractable Power Cord from an electrical outlet and retract it into the base of the Companion Lamp. In this embodiment, the Companion Lamp and/or the Digital Lampshade Display may be powered via an Internal Rechargeable Battery 406. In one embodiment, the Internal Rechargeable Battery may be charged/recharged when the Retractable Power Cord is plugged into an electrical outlet. In another embodiment, when the Internal Rechargeable Battery is charged, power may be supplied to the Companion Lamp and/or the Digital Lampshade Display. In this embodiment, the Internal Rechargeable Battery may provide power to the Companion Lamp and/or the Digital Lampshade Display during a power outage, or when the Companion Lamp and/or the Digital Lampshade Display is being used in an area where an electrical outlet is not available, thus behaving as a backup power supply.

FIG. 7 is a cut-away illustration of a Retro-fit Digital Lampshade Display 701, for an existing lamp base. In another embodiment, the Retro-fit Digital Lampshade Display may contain all of the embodiments described above; however, in this embodiment, the Retro-fit Digital Lampshade Display may be designed to fit onto any existing lamp base on the market. In one embodiment, the Retro-fit Digital Lampshade Display may contain a Threaded Male Socket Cap 702. In this embodiment, the user may insert the Threaded Male Socket Cap into a threaded light socket on any existing lamp base on the market. In this embodiment, power may be supplied to the Retro-fit Digital Lampshade Display.

In another embodiment, the Retro-fit Digital Lampshade Display may contain Wireless Communication Facility 703. In one embodiment, the Wireless Communication Facility may contain all of the embodiments and functions described above. In another embodiment, the Retro-fit Digital Lampshade Display may contain a Touch Sensitive Illuminated Control Pad 704. In one embodiment, the user may touch the Touch Sensitive Illuminated Control Pad with a finger to adjust the lighting level of the Digital Lampshade Display and/or the light bulb.

In another embodiment, the Retro-fit Digital Lampshade Display may contain a Rigid Frame 705, which may be connected to the Wireless Communication Facility and may support the Retro-fit Digital Lampshade Display. In one embodiment, the Rigid Frame may be made from metal, plastic or any other viable, rigid composite material. In one embodiment, the Rigid Frame may be hollow to allow for the storing of electrical and data wiring to provide electricity to the Retro-fit Digital Lampshade Display; and for the transferring of electronic images to be displayed on the Exterior Surface of the Retro-fit Digital Lampshade Display.

In another embodiment, the Retro-fit Digital Lampshade Display may contain a Threaded Light Socket 706. In one embodiment, the user may inset a light bulb into the Threaded Light Socket to provide additional illumination to that of the Retro-fit Digital Lampshade Display. In another embodiment, the user may inset a light bulb into the Threaded Light Socket to provide illumination without the use of the Retro-fit Digital Lampshade Display.

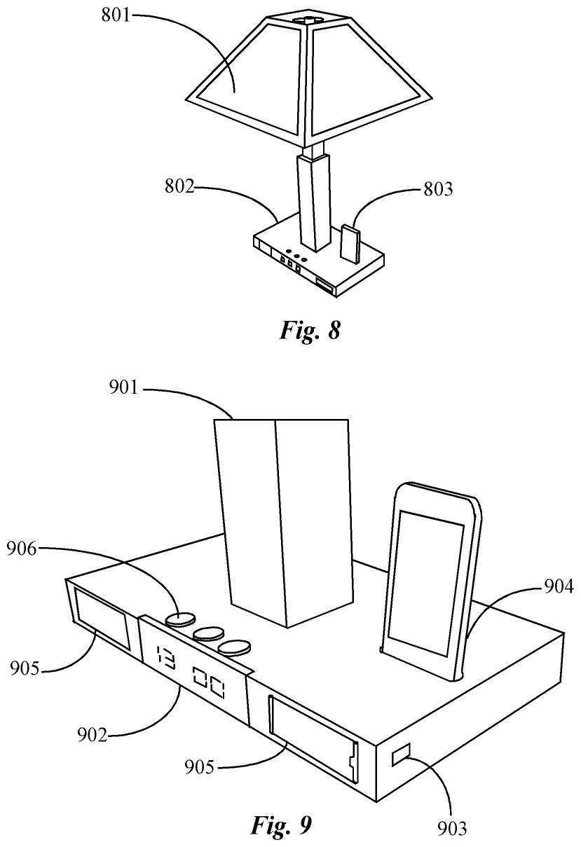

FIG. 8 is an illustration of a Tabletop Lamp 801 with a Digital Lampshade Display 801; this unit also contains a Built-in Alarm Clock 802. Also shown is a smartphone charger 803.

FIG. 9 is an illustration of a Tabletop Lamp 901, with a Digital Lampshade Display, and containing a Built-in Alarm Clock; detailing the lamp's base. In one embodiment, the Tabletop Lamp may contain a Built-in Alarm Clock 902. In one embodiment, the Built-in Alarm Clock may be set to synchronize with the Digital Lampshade Display; allowing users to program the Digital Lampshade Display to automatically turn ON with a set alarm on the Built-in Alarm Clock. In one example, the user may choose a specific graphic or full motion video (such as the sun rising or crashing waves), which may be set to be displayed along with music selected by the user.

In another embodiment, the user may upload and save music to the Built-in Alarm Clock via Data Port 903. In this embodiment, the Data Port may be a USB Port, mini USB, micro USB, memory card reader, fire wire or any other viable data port technology.

In another embodiment, the Tabletop Lamp may contain a Cradle or dock 904. In one embodiment, the Cradle may allow the user to dock their Smartphone, Cell Phone, MP3 Player, etc. to the Tabletop Lamp. In this embodiment, the user may access audio files which they have stored on their docked Smartphone, Cell Phone, MP3 Player, etc. and may play those audio files through the Tabletop Lamp's Speaker(s) 905. In another embodiment, the user may set the Tabletop Lamp to alarm and play audio files from their docked Smartphone, Cell Phone, MP3 Player, etc. In another embodiment, the Built-in Alarm Clock may be set to automatically synchronize to any alarm that is set on the user's docked Smartphone, Cell Phone, MP3 Player, etc. In one embodiment the dock contains adapters for other devices as they become available. In another embodiment these adapters are built into the base of the unit and spin on a detent so that you can spin to select a different adapter. IF you have an Iphone you can use one adapter, if you have a Samsung phone you can spin to another adapter. This insures that a maximum number of

[symbol]

In another embodiment, the user may use Control Button(s) 906, to control or adjust any audio being played on the Tabletop Lamp. In another embodiment, the user may control or adjust any audio being played on the Tabletop Lamp with a wireless remote.

In another embodiment, the user may access photos and/or video files which they have stored on their docked Smartphone, Cell Phone, MP3 Player, etc. and may display those photos and/or video files on the Tabletop Lamp's Digital Lampshade Display. In another embodiment, the user may set the Tabletop Lamp to alarm and play photos and/or video files from their docked Smartphone, Cell Phone, MP3 Player, etc. on the Tabletop Lamp's Digital Lampshade Display.

In another embodiment, the user may use Control Button(s) 906, to control or adjust any photos and/or video files being played on the Tabletop Lamp's Digital Lampshade Display. In another embodiment, the user may control or adjust any photos and/or video files being played on the Tabletop Lamp's Digital Lampshade Display with a wireless remote.

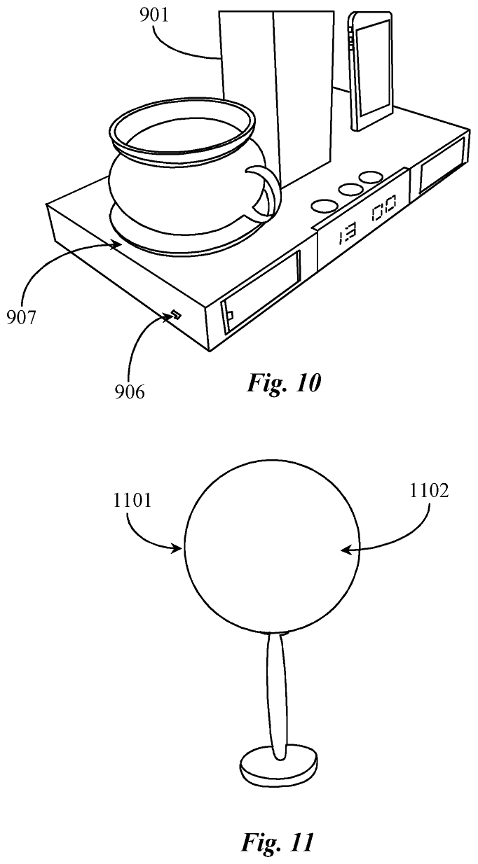

FIG. 10 is an illustration of a Tabletop Lamp 901, with a Digital Lampshade Display, and containing a Cup Warmer; detailing the lamp's base. In another embodiment, the Tabletop Lamp may contain all of the embodiments described above; however, in this embodiment, the Tabletop Lamp may contain a Cup Warmer 907. In one embodiment, the user may place a cup containing a hot beverage (such as coffee or tea) onto the Cup Warmer to keep it warm. In another embodiment, the Tabletop Lamp may contain a Cup Warmer ON/OFF Switch 908. In one embodiment, the user may rock the Cup Warmer ON/OFF Switch to the ON position to activate the heating element used to keep a cup warm. In another embodiment, the user may rock the Cup Warmer ON/OFF Switch to the OFF position to deactivate the heating element used to keep a cup warm.

FIG. 11 is an illustration of an Orb-Shaped Digital Lampshade Display 1101. In one embodiment, the Digital Lampshade Display may be applied to any formed shape, such as an Orb. In this embodiment, the Orb-Shaped Digital Lampshade Display may display images three dimensionally on its Exterior Surface. (For example, the Orb-Shaped Digital Lampshade Display may display an image of the Earth, Moon, or any other planet; thus becoming an Interactive Touch screen Globe.) In one embodiment, the Orb-Shaped Digital Lampshade Display may contain proprietary software and an internet connection (via Wi-Fi), which enables it to display real-time, satellite images such as storms, clouds, etc. In another embodiment, the Orb-Shaped Digital Lampshade Display may contain software which may allow for 24-Hour Solar Cycle Display and Tracking 1102, in real-time. In this embodiment, the Orb-Shaped Digital Lampshade Display may display the day/night cycle, by displaying one area of the Earth in light and the other in darkness. In another embodiment, the proprietary software may cause the image being displayed on the Exterior Surface of the Orb-Shaped Digital Lampshade Display to have the appearance of a rotation. In another embodiment, the user may download and install interactive software (such as Google Earth) to the Orb-Shaped Digital Lampshade Display. In this embodiment, the Orb-Shaped Digital Lampshade Display may provide the user with a three dimensional, interactive experience; allowing the user to touch on selected geographic areas to view data, points of interest, photos, etc.

In another embodiment, the Digital Lampshade Display may be applied to another orb shape, such as a bauble. In one example, the bauble may be a Christmas ornament or any other type of decorative ornament.

In one embodiment, the bauble may contain a Plug-In Module (such as USB) to allow it to be quickly plugged and unplugged from a cable. In this embodiment, the Plug-In Module may allow the user to connect the bauble to a cable to download static and/or full motion digital imagery to it. In another embodiment, the user may download static and/or full motion digital imagery to the bauble via Wi-Fi, or any other viable wireless frequency such as bluetooth or BLE.

In another embodiment, the bauble(s) may be suspended together from a cable. In one embodiment, one end of the cable may be plugged into an electrical outlet, while the rest of the cable may be hung on or around a Christmas tree. In this embodiment, power may be provided to the bauble(s) to display the static and or full motion digital imagery.

In one embodiment, the bauble may contain an Internal Battery. In one embodiment, the Internal Battery may be charged/recharged when the bauble is plugged into the cable. In another embodiment, when the Internal Battery is fully charged, the user may disconnect the bauble(s) from the cable and hang them up anywhere the user chooses. In this embodiment, the disconnected baubles may display static and/or full motion digital imagery for as long as the Internal Battery maintains a charge.

In yet another embodiment the bauble(s) may display static and/or full motion digital imagery and be choreographed together to emulate a running river of some other dynamic imagery that requires all baubles to cooperate dynamically.

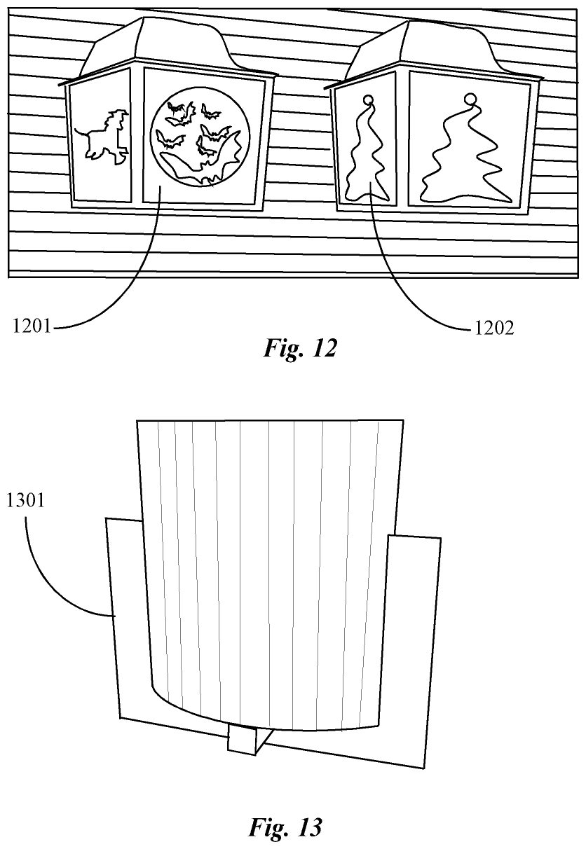

FIG. 12 is an illustration of a Porch Light Digital Display 1201, according to the embodiment of the present invention. In one embodiment, the Porch Light Digital Display may be made from glass, plastic or any other viable material. In one embodiment, the Porch Light Digital Display may contain all of the embodiments described above. In another embodiment, the digital display may be either integrated into the Porch Light Digital Display or adhered to its Exterior or Interior Surface. In another embodiment, all of the electronic components, wiring, etc. may be housed inside of the Porch Light Digital Display's Rigid Frame and may provide a seamless look when installed. All electronics such as an integrated chip with memory and a microprocessor are included in the frame. These electronics are similar to the electronics shown in FIG. 3B. In another embodiment, the user may download (via Wi-Fi) a specific theme (such as a holiday theme) to be displayed on the Porch Light Digital Display.

FIG. 13 is an illustration of a Light Sconce Digital Display 1301, according to the embodiment of the present invention. In one embodiment, the Light Sconce Digital Display may be made from glass, plastic or any other viable material. In one embodiment, the Light Sconce Digital Display may contain all of the embodiments described above. In another embodiment, the digital display may be either integrated into the Light Sconce or adhered to its Exterior or Interior Surface. In another embodiment, all of the electronic components, wiring, etc. may be housed inside of the Light Sconce Digital Display's Rigid Frame and may provide a seamless look when installed. In another embodiment, the user may download (via Wi-Fi) a specific theme (such as a holiday theme) to be displayed on the Light Sconce Digital Display.

Although the description above contains specificities, these should not be construed as limiting the scope of the invention but as merely providing illustrations of some of the presently illustrated embodiments of this invention. Thus the scope of this invention should be considered in light of the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

Although the invention has been described with respect to a particular apparatus and method for its use, it will be appreciated that various modifications of the apparatus and method are possible without departing from the invention, which is defined by the claims set forth below.

What is claimed is:

1. A digital lampshade display comprising a lampshade, said lampshade being composed of a flexible material operable to be wrapped about the exterior of a formed shape and further operable to display digital images and non-static motion imagery for viewing by a user, wherein the flexible material comprises any one or more of the following: Organic Light Emitting Diodes (OLED), Active-Matrix Organic Light-Emitting Diodes (AMOLED), Organic Light Emitting Transistors (OLET), and/or E-Ink.

2. The digital lampshade display of claim 1, further comprising a rigid frame composed of any of the following: metal, plastic, glass, and/or composite material.

3. The rigid frame of claim 2, further comprising a hollow core operable to store electrical and data wirings, wherein said wirings are operable to transmit electricity and electronic images to the digital lampshade display.

4. The digital lampshade display of claim 1, further comprising a semi-transparent layer of fabric operable to be wrapped over an exterior surface of the digital lampshade display.

5. The digital lampshade display of claim 1, further comprising a USB connection to the companion lamp.

6. The digital lampshade display of claim 1, further comprising a wireless communication facility, wherein a user may pair a computer or smartphone to the wireless communication facility via Bluetooth and/or Wi-Fi, and wherein the user may control the digital lampshade display and/or the companion lamp via the paired computer or smartphone to perform any of the following: downloading and displaying pre-set image or video files from the Internet or from stored media on the computer or smartphone; turning the companion lamp or digital lampshade display on or off; turning audible sound levels up or down; and/or, selecting brightness of the companion lamp or digital lampshade display.

7. The digital lampshade of claim 1 further comprising a companion lamp.

8. The companion lamp of claim 7, further comprising a data port such as a memory card reader operable to load images, patterns and/or video files.

9. The companion lamp of claim 7, further comprising a touch sensitive illuminated control pad, wherein the user may touch the touch sensitive illuminated control pad with a finger to adjust the lighting level of the digital lampshade display and/or a light bulb.

10. The companion lamp of claim 7, further comprising any of the following: a retractable power cord, an internal rechargeable battery, an alarm clock, audio speakers, a beverage cup warmer, and/or a docking cradle.

11. The docking cradle of claim 10, being further operable to recharge any of the following: a smartphone, cell phone, and/or an MP3 player.

12. The digital lampshade display of claim 1, further comprising an orb shape, wherein three dimensional images or video files are operable to be displayed and/or rotated, such as that of the Earth, the Moon, and/or cloud formations.

13. The digital lampshade display of claim 12, further comprising touch control operable to provide the user with an interactive experience via touching the orb to view additional data, magnification, and/or related visual media.

14. The digital lampshade display of claim 12 being further operable to be disconnected from the companion lamp and applied to covering a round bauble such as a Christmas tree ornament.

15. The digital lampshade display of claim 1 being further operable to be disconnected from the companion lamp and applied to covering a light sconce.

16. The digital lampshade display of claim 1 being further operable to retrofit onto an existing companion lamp via a threaded male socket cap which can be inserted into a threaded light socket of the companion lamp, wherein the digital lampshade display further comprises a wireless communication facility such as Bluetooth or Wi-Fi.
